(19) United States
(12) Patent Application Publication
(10) Pub. No.: US 2021/0201355 A1
(43) Pub. Date: Jul. 1, 2021

(54) SYSTEM AND METHOD FOR PROVIDING A MOBILE REAL-WORLD HYPERLINK USING A VEHICLE

(71) Applicant: PANASONIC INTELLECTUAL PROPERTY MANAGEMENT CO., LTD., Osaka (JP)

(72) Inventors: Jan Jasper van den BERG, London (GB); David Michael DUFFY, Zurich (CH)

(73) Assignee: PANASONIC INTELLECTUAL PROPERTY MANAGEMENT CO., LTD., Osaka (JP)

(21) Appl. No.: 17/201,313

(22) Filed: Mar. 15, 2021

Related U.S. Application Data
(63) Continuation of application No. PCT/JP2019/037395, filed on Sep. 24, 2019.
(60) Provisional application No. 62/735,272, filed on Sep. 24, 2018.

(51) Int. Cl. G06Q 30/02; G06K 9/00; B60W 60/00; H04W 84/18

(52) U.S. Cl. CPC G06Q 30/0266; G06K 9/00791; B60W 2540/225; B60W 60/001; H04W 84/18; G06K 9/00355

(57) ABSTRACT

A method for supporting a nomadic mobile servicing vehicle, and a system for implementing the method are provided. The method includes transmitting, by a first vehicle and to a server, a promotion request, the promotion request specifying a location of the first vehicle. The method further includes acquiring environment attributes of an environment within a reference distance of the location of the first vehicle, and extracting conditions specified in the promotion request. The method also includes transmitting, to a third vehicle, the promotion request for fulfillment, determining a promotion route within a predetermined distance range, and executing, by the third vehicle, a promotion operation while traveling along the promotion route.

### CROSS-REFERENCE TO RELATED APPLICATIONS

This application is a continuation of PCT International Patent Application No. PCT/JP2019/037395 filed on Sep. 24, 2019, which claims the benefit of priority of U.S. Provisional Patent Application No. 62/735,272 filed on Sep. 24, 2018, the entire contents of which are incorporated herein by reference.

### FIELD

The present disclosure relates to utilizing vehicles to facilitate ad-hoc promotion performances by one or more vehicles for a nomadic vehicle facilitating a mobile business.

### BACKGROUND

Self-driving vehicles can increasingly interpret hand gesture signals of humans on a street, which is useful e.g. for hailing an autonomous taxi service. Vehicles will have various ways to change their appearance in order to interact with pedestrians, such as using displays, lights, speakers, and on-road projectors. A range of future mobility services are envisioned, such as mobile service platforms, RoboMarts, self-preparing food vans and taxi services which may differentiate by branded appearance, such as Continental's feel-good cocoon.

Mobile advertisement signs, e.g. on a bus or taxi, are usually showing a static image or a fixed animation/movie, there is no coordination of the advertisement being shown between several vehicles, there is no or limited location dependence of the advertisement, no adaption to the status of nearby service supply/user demand/other environmental influences (e.g. if a street is busy, street sentiments), no feedback to users showing interest or wanting to follow up on an advertisement and no tracking of user actions such as purchases.

Extended advertisement on responsive billboards may have sensors available to them to create an advertisement responsive to the environment, e.g. a user action. However, such advertisement systems have several issues. For example, billboard advertisement may not likely be present at locations of interest or demand, as they are static. Billboard advertisement also has limited capabilities to respond to user actions (such as viewing or walking direction), as they can only control the timing of promotion, but not the location. Further, billboard advertisement has no real-time response to promotion requests of nearby mobile services. Billboard advertisement may also have limited capabilities to detect a user reaction to the promotion as they likely have limited imaging capabilities/analytic software, again available from only one static location. Lastly, billboard advertisement also lack a reward system for actual effectiveness of the advertisement, e.g. if the advertisement leads to a purchase.

Internet enabled mobile phone applications can be used to receive real-time information about nearby services. However, they only function when a user chooses to use it, they require the user to have knowledge of specific websites or service applications and in general require active searching from the user, which may be inconvenient for the user or may be undesirable for the offered service, e.g. if the user is not aware of the service (relatively unknown local service).

### SUMMARY

A system and method to execute a coordinated promotion of a product or service between at least two vehicles and then collect proof of user actions of interest in response to the promotion (gauging the pedestrian's attention, detecting gesture signals), optionally including a payment/purchase. The coordinated promotion may be in response to a detected event or other environmental attributes.

This would enable mobile service vehicles to cooperate with other vehicles to enhance the likelihood of people on the street being aware of the service and to help people ordering the service from nearby locations.

Vehicles may be rewarded for their contribution to the coordinated promotion, such contributions being e.g. showing advertisements, referrals, collection of data, assistance in bringing together a mobile business and a user, or facilitating a purchase.

According to various aspects of the present disclosure, a method for creating and fulfilling a promotion request is disclosed. The method includes creating a promotion request by a first vehicle providing a mobile service and communicating such a request to a second vehicle; and the second vehicle determining if the conditions of a promotion request are met. Aspects of the present disclosure further disclose a system and method for the second vehicle to execute a requested promotion according to a set of conditions set by the first vehicle, in which the second vehicle collects proof of a user action in response to the executed promotion.

Further, according to another aspect of the present disclosure, the method further disclose determining to what extent the user makes use of the mobile service provided by the first vehicle; and rewarding the second vehicle for collecting the proof of the user action if the user action leads to a purchase, payment or other desired interaction with the first vehicle providing the mobile service.

According to aspects of the present disclosure, coordinated actions to promote a mobile service between the vehicle offering the service and other vehicles promoting the service may be provided. Further, location coverage/exposure range of the vehicles providing the mobile service may be expanded. Also, a user response to the promotion of the mobile service, e.g. to improve the delivery of the service, to allow the user to order the service from a nearby location may be captured. In addition, vehicles using various capabilities to execute a requested promotion may be rewarded.

### BRIEF DESCRIPTION OF DRAWINGS

FIG. 1 shows an exemplary general computer system, according to an aspect of the present disclosure.

FIG. 2 shows an exemplary network environment for generating and fulfilling a promotion request, according to an aspect of the present disclosure.

FIG. 3 shows an exemplary system environment for generating and fulfilling a promotion request, according to an aspect of the present disclosure.

FIG. 4A shows an exemplary method for generating and fulfilling a promotion request using various vehicles, according to an aspect of the present disclosure.

FIG. 4B show an exemplary method for generating and fulfilling a promotion request using various vehicles, according to an aspect of the present disclosure.

FIG. 5 illustrates a method for determining a promotion route with respect to a positioning of a service offering vehicle, according to an aspect of the present disclosure.

FIG. 6 shows a method for matching a promotion request to a promotion vehicle, according to aspects of the present disclosure.

FIG. 7 shows a method for identifying a proof collection device for deployment, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

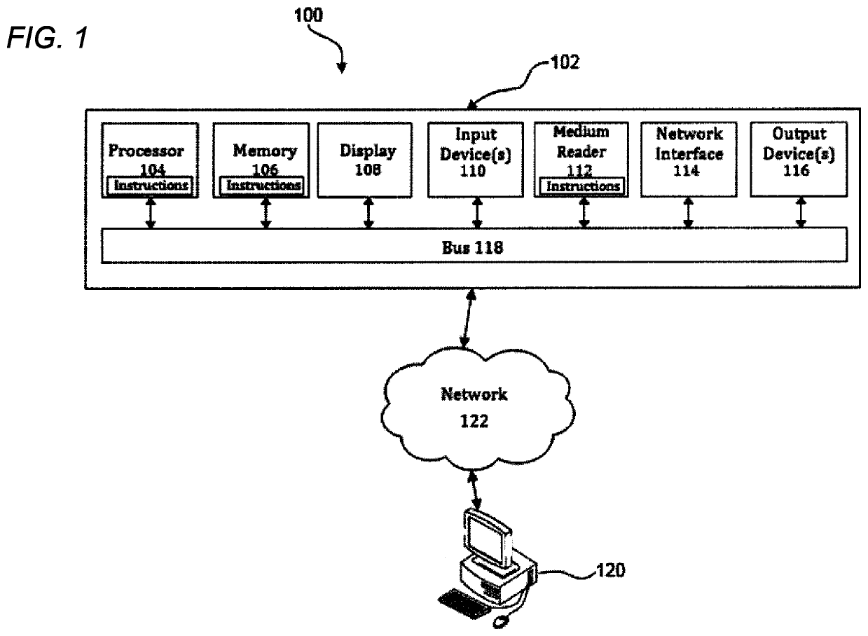

FIG. 1 is an exemplary computer system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read anyone or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present disclosure, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present disclosure. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

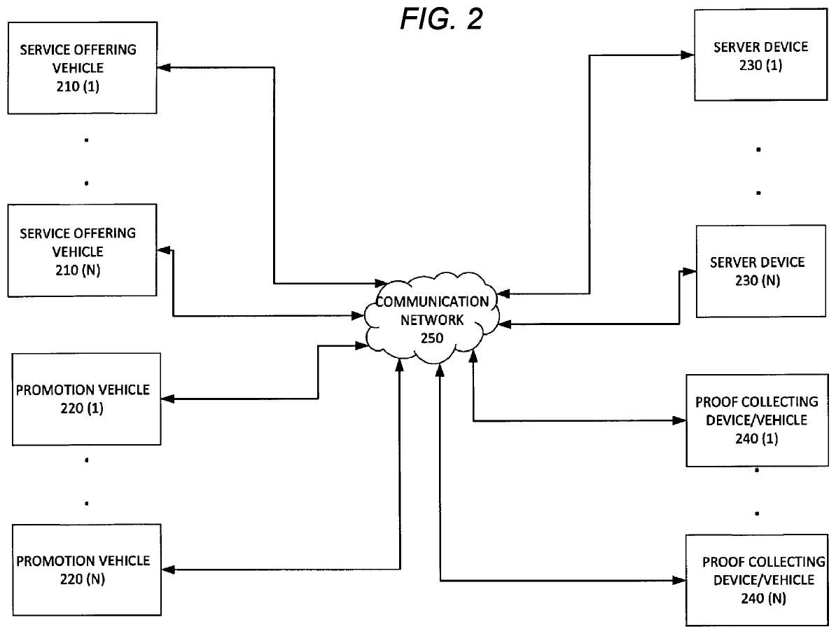

FIG. 2 shows an exemplary network environment for generating and fulfilling a promotion request, according to an aspect of the present disclosure.

Referring to FIG. 2, a schematic of an exemplary network environment for generating and fulfilling an action request is illustrated. In an exemplary embodiment, action request generation/fulfilment framework is executable on a networked computer platform.

In the network environment of FIG. 2, a plurality of service offering vehicles 210(1)-210(N), a plurality of promotion vehicles 220(1)-220(N), a plurality of server devices 230(1)-230(N), and a plurality of proof collecting device/vehicle 240(1)-240(N) may communicate via communication network(s) 250.

A communication interface of a service offering vehicle, such as the network interface 114 of the computer system 102 of FIG. 1, operatively couples and communicates between the promotion vehicles 220(1)-220(N), the server devices 230(1)-230(N), proof collecting device/vehicles 240(1)-240(N), which are all coupled together by the communication network(s) 250, although other types and/or numbers of communication networks or systems with other types and/or numbers of connections and/or configurations to other devices and/or elements may also be used.

The communication network(s) 250 may be the same or similar to the network 122 as described with respect to FIG. 1, although the service offering vehicles 210(1)-210(N), promotion vehicles 220(1)-220(N), the server devices 230(1)-230(N), and/or the proof collecting devices/vehicles 240(1)-240(N) may be coupled together via other topologies. Additionally, the network environment may include other network devices such as one or more routers and/or switches, for example, which are well known in the art and thus will not be described herein.

By way of example only, the communication network(s) 250 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 250 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

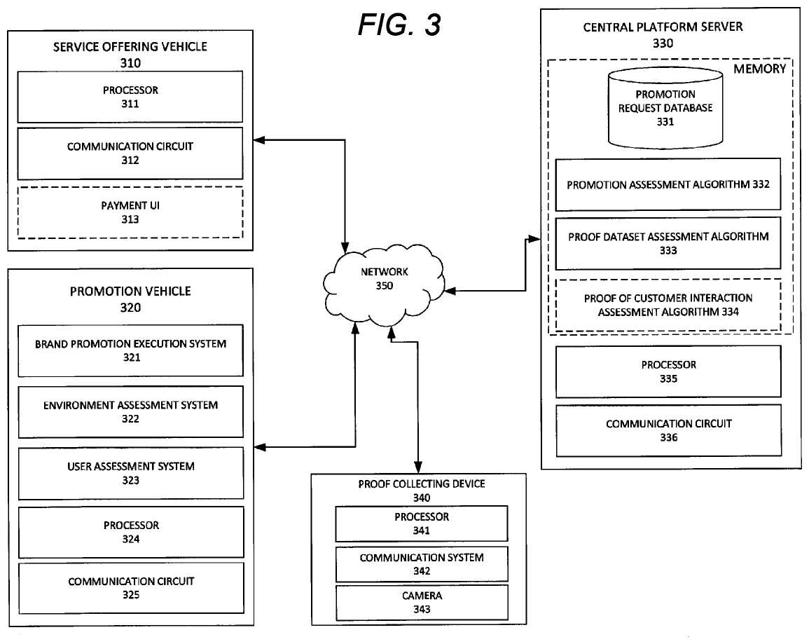

The plurality of server devices 230(1)-230(N) may individually or collectively implement a central platform server as exemplarily illustrated in FIG. 3. Further, the plurality of server devices 230(1)-230(N) may be the same or similar to the computer system 102 or the computer device 120 as described with respect to FIG. 1, including any features or combination of features described with respect thereto. For example, any of the server devices 230(1)-230(N) may include, among other features, one or more processors, a memory, and a communication interface, which are coupled together by a bus or other communication link, although other numbers and/or types of network devices may be used. The server devices 230(1)-230(N) in this example may process requests received from a client device via the communication network(s) 250 according to the HTTP-based and/or JavaScript Object Notation (JSON) protocol, for example, although other protocols may also be used.

The server devices 230(1)-230(N) may be hardware or software or may represent a system with multiple servers in a pool, which may include internal or external networks.

Although the server devices 230(1)-230(N) are illustrated as single devices, one or more actions of each of the server devices 230(1)-230(N) may be distributed across one or more distinct network computing devices that together comprise one or more of the server devices 230(1)-230(N). Moreover, the server devices 230(1)-230(N) are not limited to a particular configuration. Thus, the server devices 230(1)-230(N) may contain a plurality of network computing devices that operate using a master/slave approach, whereby one of the network computing devices of the server devices 230(1)-230(N) operates to manage and/or otherwise coordinate operations of the other network computing devices.

The server devices 230(1)-230(N) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of service offering vehicles 210(1)-210(N) and/or the plurality of promotion vehicles 220(1)-220(N) may also include a computing device, which may have a similar configuration to the computer system 102 or the computer device 120 as described with respect to FIG. 1, including any features or combination of features described with respect thereto. For example, the computing device included in the plurality of service offering vehicles 210(1)-210(N) and/or the plurality of promotion vehicles 220(1)-220(N) in this example may include any type of computing device that can facilitate the execution of a web application or analysis that relates to an API. Accordingly, the computing device included in the plurality of service offering vehicles 210(1)-210(N) and/or the plurality of promotion vehicles 220(1)-220(N) may include, without limitation, be mobile computing devices, laptop computing devices, tablet computing devices, or the like, that connects with a respective vehicle and hosts chat, e-mail, or voice-to-text applications, for example. Further, the computing device included in the plurality of service offering vehicles 210(1)-210(N) and/or the plurality of promotion vehicles 220(1)-220(N) may additionally be equipped with or communicates with one or more sensors.

The computing devices included in the plurality of service offering vehicles 210(1)-210(N) and/or the plurality of promotion vehicles 220(1)-220(N) may run interface applications, such as standard web browsers or standalone client applications, which may provide an interface to communicate with one or more of vehicles, one or more of the proof collecting devices/vehicles 240(1)-240(N) and/or one or more of the server devices 230(1)-230(N) via the communication network(s) 250 in order to communicate user requests. The computing device included in the plurality of service offering vehicles 210(1)-210(N) and/or the plurality of promotion vehicles 220(1)-220(N) may further include, among other features, a display device, such as a display screen or touchscreen, and/or an input device, such as a keyboard, for example.

The proof collecting devices/vehicles 240(1)-240(N) may collect or capture proof of evidence of performance for the promotion request submitted by one or more of the plurality of service offering vehicles 210(1)-210(N). In an example, the proof collecting devices/vehicles 240(1)-240(N) may be one of the promotion vehicles 220(1)-220(N), a separate vehicle with proof collecting actuators (e.g., camera, microphone, light measurer, and etc.), an unmanned aerial vehicle (e.g., drone) with proof collecting actuators, an unmanned ground vehicles or the like.

Although the exemplary network environment with the plurality of service offering vehicles 210(1)-210(N), the plurality of promotion vehicles 220(1)-220(N), the server devices 230(1)-230(N), the proof collecting devices/vehicles 240(1)-240(N), and the communication network(s) 250 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as the server devices 230(1)-230(N), for example, may be configured to operate as virtual instances on the same physical machine. In other words, one or more of the server devices 230(1)-230(N) may operate on the same physical device rather than as separate devices communicating through communication network(s) 250.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

FIG. 3 shows an exemplary centralized system environment for generating and fulfilling a promotion request, according to an aspect of the present disclosure.

System of FIG. 3 includes a service offering vehicle 310, a promotion vehicle 320, a central platform server 330, a proof collecting device 340 and a network 350. The service offering vehicle 310, the promotion vehicle 320, the central platform server 330 and the proof collecting device 340 are connected via the network 350.

The service offering vehicle 310 may include a vehicle, such as a taxi or a mobile shop, which may offer a mobile service. More specifically, the service offering vehicle 310 may be nomadic and travel to various locations to provide a service. In an example, the service offering vehicle 310 may be configured to provide a service within the service offering vehicle 310 (e.g., consultation services, tax service, and etc.), or provide a service at the service offering vehicle 310 (e.g., mobile retail service). In an example, the service offering vehicle 310 may drive through a newly built home community and provide a blind installation service. In an example, the service offering vehicle 310 may have autonomous capabilities in varying ranges (e.g., from fully autonomous to semi-autonomous). The service offering vehicle 310 includes a processor 311 and a communication circuit 312. The service offering vehicle 310 may optionally include a payment user interface (UI) 313. Further, although not illustrated, the service offering vehicle 310 may be additionally equipped with a routing system, a suite or sensors (e.g., lidar/radar, GPS sensor, speed sensor, microphone, and etc.).

The processor 311 may perform one or more operations of the self offering vehicle 310. Further, the processor 311 may process an input receive via the communication circuit 312. The communication circuit 312 may be configured to communicate with one or more of the promotion vehicle 320, the central platform server 330, and the proof collecting device 340 via the network. In an example, the communication circuit 312 may include a transmitter, a receiver, and/or a transceiver.

The payment user interface 313 may be an interface to resolve payments/purchases of a user making use of a mobile service and able to collect a proof of payment. In an example, the proof of payment may be a dataset which can be used to confirm that the payment has taken place and potentially other relevant details of the payment, such as quantity, number of products, or the like.

In an example, the mobile service may refer to a car-centred or other vehicle-centred service provided to customers on the street or potentially to occupants of different vehicles or buildings. More specifically, the mobile service may be a physical service rendered using a vehicle, which is distinguished from mobile services provided by, for example a telecommunication service for a mobile device. The mobile service may include a service rendered within the vehicle or at the vehicle. According to aspects of the present disclosure, the mobile service may include, without limitation, a mobile retail, a taxi service, a mobile workspace, a nap station, a space rental, in-vehicle education/lessons, financial services/consults, health care/health service/personal grooming, entertainment, and tourism/hospitality services. In an example, mobile retail may include, without limitation, mobile shops and/or delivery of offered products. Offered products, in an example, may be beverages, food, fashion, consumer electronics and the like. The taxi service may include, without limitation, ride hailing, transportation to/from brick-and-mortar stores/restaurants, integration with city/mobility services.

The promotion vehicle 320 may be a vehicle that may be equipped with various equipment or actuators (e.g., displays, sound system, lighting system, movable spoilers, motorized body parts, and etc.), which may be utilized to bring attention to a particular promotion being advertised by the promotion vehicle 320. In an example, the promotion vehicle 320 may play advertisement videos/images/songs, project images, emit light, provide a description of the mobile service, provide a location of the mobile service, take reservations/appointments, and otherwise bring attention to itself by use of its actuators. The promotion vehicle 320 includes a brand promotion execution system 321, an environment assessment system 322, a user assessment system 323, a processor 324 and a communication circuit 325.

The promotion vehicle 320 may include a vehicle of varying types, which may be equipped with certain set of actuators available for providing a promotion operation or performance. In an example, the promotion vehicle 320 may have autonomous capabilities in varying ranges (e.g., from fully autonomous to semi-autonomous).

The brand promotion execution system 321 may be a system configured to execute a brand promotion request. In an example, a brand promotion may refer to an act of executing any action (e.g., display of advertisement, outputting of certain displays or sounds for attracting attention to a particular location or business) to promote a brand, a product or a mobile service using one or more capabilities of a vehicle. According to aspects of the present disclosure, brand promotion actions may include, without limitation, (i) showing advertisement images, logos, videos and/or animations on the external surface of the vehicle, (ii) changing of color or color patterns on a vehicle's body, (iii) changing of lighting settings of the vehicle's internal or external lighting systems, (iv) projections on non-vehicle surfaces, such as roads, sidewalks, walls and etc., (v) changing an appearance of the vehicle's exterior (e.g., setting of a spoiler, opening of windows/doors, removal of roof), (vi) changing an appearance of the vehicle's interior (e.g., change of seat position, change display of products, change configuration of seats or other objects in the vehicle), (vii) audio actions (e.g., playing sounds, music, speech or etc.); (ix) moving to increase exposure to and/or attract attention of potential customer within range (e.g., within a line-of sight or within a reference radius from the location of the mobile service) of the brand promotion (e.g., change of speed, changing of lane, or etc.), and (x) re-routing the vehicle to a different location (e.g., different street) to change which potential customers are within range (e.g., within line-of sight).

According to aspects of the present disclosure, the brand promotion execution system 321 may include a system of actuators. The system of actuators includes, without limitation, an externals screen/display, a transparent display, controllable color changing material, headlights, in-car illumination system, a light projector (e.g., projector that projects one or more images on a nearby surface, such as a road), moving car parts with controllable settings (e.g., windows, electronically controlled car roof, seats with variable position/location within the car), internal/external speakers, driving assistance system and interface, and/or autonomous driving system. The driving assistance system and interface may be able to guide the promotion vehicle driver along a certain route and/or instruct them to perform a certain driving action such as changing speed, changing lane and the like. The autonomous driving system may be able to autonomously control one or more aspects of the vehicle. For example, the autonomous driving system may be able to steer a vehicle towards a certain location, control placement on the road, and/or change the vehicle's speed.

The environment assessment system 322 may be a system including various components configured to collect a dataset of an environment of an area within a reference range or distance from a location of the promotion vehicle 320, or environment attributes. In an example, the environment assessment system 322 may include an imaging sensor systems, one or more sensors, various analysis algorithms, a navigation system and internet-connected applications.

In an example, the imaging sensor systems may include a camera, a lidar and a radar. The one or more sensors may include an audio sensor, a distance sensor, a GPS sensor, a biological sensor (e.g., contact or contactless sensor), and an air quality sensor. The analysis algorithms may include one or more algorithms stored in a memory of the promotion vehicle, which may be accessed and executed by the processor 324. The analysis algorithms may include, without limitation, algorithms able to analyze raw sensor input collected by the one or more sensors for filing relevant environment attributes. In an example, the analysis algorithms may include computer algorithms able to determine the person count or human activity type within a given image, algorithms able to detect emotion from audio. In an example, the navigation system may be a vehicle-to-vehicle and/or vehicle-to-infrastructure communication system able to receive information from other sources about the status of the road, traffic conditions, or a particular route the promotion vehicle. In an example, the internet-connected applications may detect sentiments or other location-based information from social media feeds, blogs, or other internet sources.

According to aspects of the present disclosure, the environment attributes include, without limitation, a number/density of people within a given distance from the promotion vehicle 320, traffic level or level of congestion, a number of other mobile services within a certain travel time of a location, points of interest/activities/events taking place on the streets, vehicle occupancy and type of other nearby vehicles, and a mood/sentiment type of a location/street/neighborhood. In an example, the determined environment attributes may be stored at the promotion vehicle 320 and/or may be transmitted to the central platform server 330. The environment attributes may be transmitted in real-time, and may be transmitted by a promotion vehicle assigned to perform a promotion operation or by a promotion vehicle (or other vehicles) passing through an area (and surrounding areas) at which a promotion request is to be fulfilled.

The user assessment system 323 may be a system including various components that are able to collect a data set, or user assessment data. In an example, the user assessment system 323 may include one or more sensors to collect raw data about the user's interaction/activities during or in response to the brand promotion. The user assessment system 323 may also include one or more algorithms that are able to analyze raw sensor input and find relevant user assessment data within that sensor input (e.g., gesture recognition, gaze tracking, emotion recognition and etc.). In an example, the one or more algorithms of the user assessment system 323 may be stored in a memory of the promotion vehicle, which may be accessed and executed by the processor 324. The user assessment data may include, without limitation, a type of movement of the user, a gesture made by the user, an user interaction with/input to a user interface belonging to the vehicle or to the user (e.g., mobile device), a gaze direction/duration of the user, an emotional state of the user, and voice of the user.

The user assessment data can be obtained by the examples as follows: the type of movement of the user or the gesture made by the user, for example, the user's nod, can be obtained using camera recognition; the user interaction with/input to the user interface belonging to the vehicle or to the user (e.g., mobile device), for example, the operation by the user for searching information and thereafter clicking a portion of the related web site, can be obtained using a sensor for detecting the click operation, a fingerprint sensor, a gravity sensor, etc.; the gaze direction/duration of the user can be obtained using camera recognition; the emotional state of the user can be obtained using millimeter-wave measurement which can detect sympathetic and parasympathetic nerve activities of the user, a pressure sensor which can detect the pulse wave of the user, etc.; and the voice of the user can be obtained using microphone coupled to a speech recognition engine, for example, for picking up the voice if a word related to the information provided by the promotion vehicle is recognized.

The processor 324 may perform one or more operations of the brand promotion execution system 321, the environment assessment system 322, and the user assessment system 323. Further, the processor 324 may process an input receive via the communication circuit 325. The communication circuit 325 may be configured to communicate with one or more of the service offering vehicle 310, the central platform server 330, other promotion vehicles and the proof collecting device 340 via the network. In an example, the communication circuit 325 may include a transmitter, a receiver, and/or a transceiver.

The central platform server 330 may be a physical server or a virtual server. The central platform server 330 includes a promotion request database 331, a promotion assessment algorithm 332, a proof dataset assessment algorithm 333, a proof of customer interaction assessment algorithm 334, a processor 335 and a communication circuit 336. The promotion request database 331, the promotion assessment algorithm 332, the proof dataset assessment algorithm 333, and the proof of customer interaction assessment algorithm 334 are included in one or more memories.

The promotion request database 331 may be a database storing multiple instances of a dataset, or a promotion request, which may be created by the service offering vehicle 310. The promotion request includes information and conditions for executing a brand promotion. In an example, the promotion request may include, without limitation, a service offering vehicle identifier (ID), desired promotion vehicle capabilities, desired environment attributes, brand promotion instructions, user assessment instructions, proof dataset collection instructions, and reward conditions.

In an example, the service offering vehicle ID may refer to information use to identify the service offering vehicle 310, such as a license plate. In addition, the service offering vehicle ID may also include or correspond to a description of the vehicle, such as make and model of the service offering vehicle 310. The desired promotion vehicle capabilities may refer to information describing a type of brand promotion actions a promotion vehicle should be capable of and optionally other desired attributes, such as vehicle make/model or vehicle occupancy. The desired environment attributes may refer to environment attributes under which the promotion vehicle 320 should execute the brand promotion. For example, the desired environment attributes may include, without limitation, desired number of people within a line-of-sight (or reference distance) of the promotion vehicle 320, detected human activity, vehicle count within a certain range, and street sentiment. The brand promotion instructions may refer to instructions describing which actions the brand promotion execution system 321 should perform. The user assessment instructions may include instructions describing which user assessment data the user assessment system 323 should collect during the brand promotion. The proof dataset collection instructions may include instructions describing which data to include in the proof dataset. The reward conditions may refer to a set of conditions which describe the reward (e.g., type, amount, and etc.) the promotion vehicle may be entitled to after performing the requested promotion activity and/or receiving the proof dataset. Optionally, the reward may be set to have a variable size/value, dependent on which of the reward conditions have been met.

The proof dataset may include a dataset which shows that the brand promotion has taken place as specified in the promotion request. The proof dataset may include, without limitation, a promotion vehicle ID, proof of brand promotion execution, environment attributes, and user assessment data. In an example, the promotion vehicle ID may refer to information use to identify the promotion vehicle 320, such as a license plate. In addition, the promotion vehicle ID may also include or correspond to a description of the vehicle, such as make and model of the promotion vehicle 320, promotion capabilities of the promotion vehicle 320, equipment available on the promotion vehicle 320 and the like. The proof of brand promotion execution may include sensor readings/other data showing that the brand promotion execution system 321 has executed the desired brand promotion instructions. In an example, these sensor readings may be provided by the promotion vehicle 320, another device (e.g., drone), and/or by a trusted third party, such as city infrastructure (e.g., safety/security/surveillance cameras, red light cameras, toll road sensors, and the like). The environment attributes, which may be included to (i) show that the desired environment attributes as described in the promotion request have been met, and/or (ii) provide the service offering vehicle desired relevant data about the environment of the promotion vehicle 320. The user assessment data, which may be included to (i) show that the user assessment instructions have been executed during the brand promotion, and/or (ii) provide the service offering vehicle desired relevant data about users near the promotion vehicle 320 and/or their reaction to a brand promotion.

The promotion assessment algorithm 332 may be an algorithm that receives a potential promotion vehicle and desired environmental attributes as input. In response, the promotion assessment algorithm 332 may output a score, value, rank or other information, which can be used to determine to what extent the promotion vehicle 320 matches a given promotion request.

The proof dataset assessment algorithm 333 may be an algorithm that receives proof dataset as input and outputs a score, a value, rank or other indicator of how well a proof dataset matches the proof dataset collection instructions as described in the promotion request.

The proof of customer interaction assessment algorithm 334 may be an algorithm receiving proof of customer interaction dataset as input, and outputs a score, value, rank or other indicating giving information, which may be used as a proxy as to how much extra revenue/profit the service offering vehicle 310 has received as a consequence of the brand promotion performed by the promotion vehicle 320. The proof of customer interaction dataset may refer to a dataset showing which transactions have taken place between the user and the service offering vehicle 310 after the brand promotion has taken place. In an example, the proof of customer interaction dataset may include sensor readings and financial records. The sensor readings, such as readings from vehicle cameras, microphones, sensors collecting biological signals or other sensors, showing the interaction between the user and the service offering vehicles. The financial records showing transaction attributes between the user and the service offering vehicle. In an example, the financial records may include, without limitation, total amount paid, number of products and the like.

In an example, the output of the proof of customer interaction assessment algorithm 334 may be used to determine an amount of reward given to the promotion vehicle 320, if described in the payment conditions.

The processor 335 may perform one or more executions in response to an input received via one or more of the promotion request database 331, the promotion assessment algorithm 332, the proof of customer interaction assessment algorithm 334 and the communication circuit 336. The processor 335 may provide an output to one or more of the promotion assessment algorithm 332, the proof of customer interaction assessment algorithm 334 and the communication circuit 336. The communication circuit 336 may be configured to communicate with the service offering vehicle 310, the promotion vehicle 320, and/or the proof collecting device 340 via the network 350. In an example, the communication circuit 336 may include a transmitter, a receiver, and/or a transceiver.

The proof collecting device 340 may be a vehicle equipped with sensing technology within a reference distance of a location at which the proof is to be collected, or an unmanned aerial device (e.g., a drone) equipped with sensors for collecting of proof of brand promotion performance. The proof collecting device 340 includes a processor 341, a communication system 342 and a camera 343. However, aspects of the present disclosure are not limited thereto, such that the proof collecting device 340 may include additional sensors for collecting of proof of brand promotion performance. Further, the central platform server 330 may deploy the proof collecting device 340 upon notification of completion is received from the promotion vehicle 320. Alternatively, the central platform server 330 may deploy the proof collecting device 340 if evidence provided by the promotion vehicle 320 is determined to be insufficient.

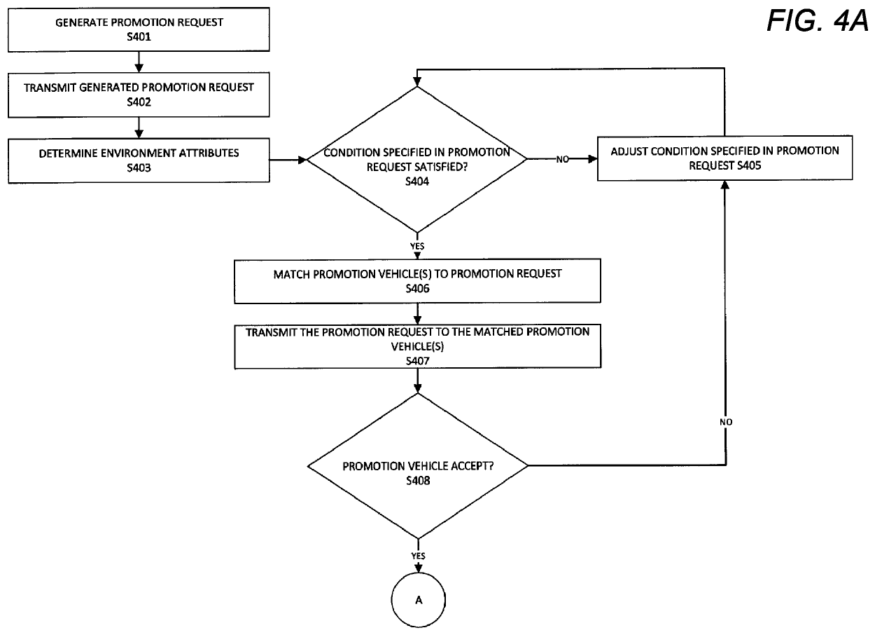

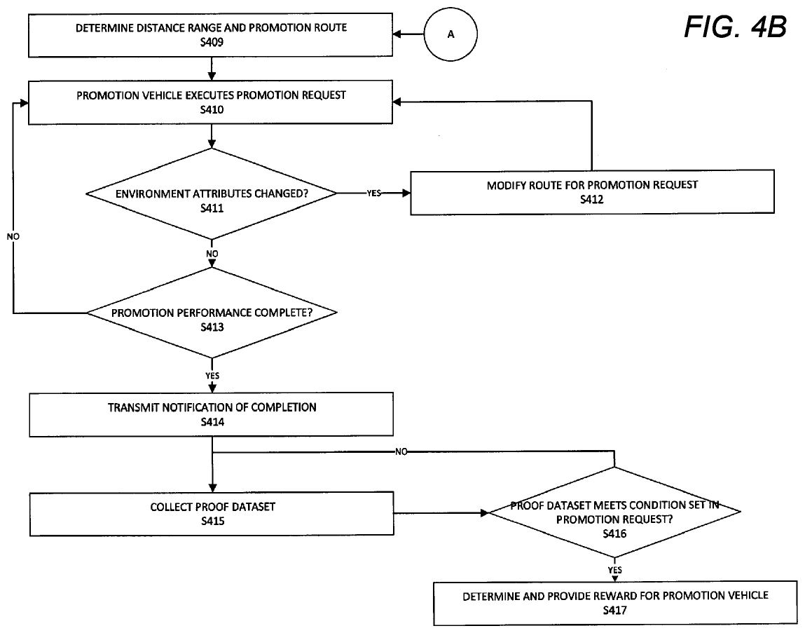

FIGS. 4A-4B show an exemplary method for generating and fulfilling a promotion request using various vehicles, according to an aspect of the present disclosure.

In operation S401, a promotion request is generated by a vehicle, such as a service offering vehicle. The promotion request includes information and conditions for executing a brand promotion. In an example, the promotion request may include, without limitation, a service offering vehicle identifier (ID), desired promotion vehicle capabilities, desired environment attributes, brand promotion instructions, user assessment instructions, proof dataset collection instructions, and reward conditions. Also, brand promotion instructions may specify a type of promotion, location of promotion, and or duration of promotion. In an example, the brand promotion instructions may be dynamically generated for various pop-up or temporary promotion events or locations. More specifically, the promotion request and the brand promotion instructions may be generated dynamically for mobile service offerings, which may modify its service locations on a frequent basis. Further, the promotion request and the brand promotion instructions may be dynamically updated if the location of the mobile service provider is modified during its operation.

In operation S402, the generated promotion request is transmitted to a central server residing over a communication network. The transmitted promotion request may be stored in a database or memory of the central server, such as a promotion request database.

In operation S403, the desired environmental attributes corresponding to the promotion request is determined. In an example, the environment attributes include, without limitation, a number/density of people within a given distance from the promotion vehicle, traffic level or level of congestion, a number of other mobile services within a certain travel time of a location, points of interest/activities/events taking place on the streets, vehicle occupancy and type of other nearby vehicles, and a mood/sentiment type of a location/street/neighborhood.

In operation S404, the centralized server determines whether conditions specified in the promotion request can be satisfied by one or more registered promotion vehicles. For example, the conditions specified in the promotion request may include, without limitation, proximity or distance from a location at which the brand promotion is to take place, capabilities/equipment provided on a vehicle, a vehicle type (e.g., convertible, truck, sports car and etc.), age or year of the vehicle, a vehicle brand, and the like. Based on the conditions specified, such a reference distance from the service offering vehicle or equipment provided on a respective vehicle, a list of potential promotion vehicles may be generated with a listing of their corresponding attributes. Further, the list of potential promotion vehicles may be ranked based on more or more factors, which may include a preference of the promotion requester, type of the promotion vehicles, experience level of the promotion vehicles, age of the promotion vehicles, and the like.

If none of the registered promotion vehicles located with a reference distance of a location at which the performance of the promotion is to take place, as specified in the promotion request, is determined to meet the conditions specified in the promotion request in operation S404, the method proceeds to operation S405. In operation S405, conditions specified in the promotion request may be modified to select from a larger pool of registered promotion vehicles. In an example, one of the modified condition may include an adjustment of the reference distance of the location at which the performance of the promotion is to take place. However, aspects of the present disclosure are not limited thereto, such that one or more of the other conditions may be modified.

If one or more promotion vehicles meets the conditions specified in operation S404, the method proceeds to operation S406. In operation S406, the promotion vehicles meeting the conditions specified in the promotion request is matched with the promotion request. In an example, the one or more promotion vehicles may be matched with the promotion request by a promotion assessment algorithm stored in a memory of the centralized server. For example, the promotion assessment algorithm may receive the promotion vehicle capabilities and the environment attributes as collected by the promotion vehicle (e.g., number of pedestrians within 30-meter radius >=22). In another example, the environment attributes may be compared with desired environment attributes (e.g., desired number of pedestrians within 30-meter radius: >15=“minimum”, >20=“desired”). In yet another example, the promotion assessment algorithm may output possible match between promotion request and promotion vehicle(s) (e.g., if one or several environment attributes score “desired”, make the match, i.e. allow the promotion vehicle to carry out the brand promotion).

In operation S407, the central server transmits the promotion request to the one or more matched promotion vehicles for acceptance.

In operation S408, a determination of whether the central server receives an acceptance from the matched promotion vehicle is made. If no acceptance, or acceptance from less than a number of promotion vehicles specified in the promotion request, is received within a predetermined period of time (e.g., 1 minute), the method proceeds to operation S405, in which one or more conditions specified in the promotion request are adjusted. For example, if no acceptance is received after 1 minute of broadcasting, the reference distance or range may be expanded more until a predetermined number of acceptances may be received.

If the predetermined number of promotion vehicles accept the promotion request in operation S408, the method proceed to operation S409. In addition, if the number of acceptances that is greater than the predetermined number are received, the central server may select a predetermined number of promotion vehicles among the accepting promotion vehicles based on a preset criteria, such as performance review of the promotion vehicle, age or year of the vehicle, type of vehicle, vehicle brand, time available for performing the requested promotion, cost for performing the requested promotion and the like.

In operation S409, the central server or the promotion vehicle determines a distance range from the location of the service offering vehicle and further determines a promotion route within the distance range based on the promotion request and/or one or more of the environment attributes. In an example, the promotion request may specify the promotion vehicle to perform a promotion while traveling within a quarter mile radius from the location of the service offering vehicle. Further, the promotion request may specify the promotion vehicles to perform a promotion while traveling to one or more select areas having a population density above a reference threshold within the quarter mile radius. More specifically, a promotion route may be set to pass by the one or more of the select areas having the population density above the reference threshold within the distance range from the location of the service offering vehicle. In an example, the population density may be determined based on the environmental attributes within the distance range. The environmental attributes may be provided by the promotion vehicle, the service offering vehicle and/or other vehicles passing through the area included in the distance range.

In operation S410, the promotion vehicle executes the promotion request as specified in the promotion request and/or in view of one or more environment attributes. In an example, the promotion vehicle may execute the promotion following a promotion execution instructions included in the promotion request. In an example, promotion performance may include, without limitation, (i) showing advertisement images, logos, videos and/or animations on the external surface of the vehicle, (ii) changing of color or color patterns on a vehicle's body, (iii) changing of lighting settings of the vehicle's internal or external lighting systems, (iv) projections on non-vehicle surfaces, such as roads, sidewalks, walls and etc., (v) changing an appearance of the vehicle's exterior (e.g., setting of a spoiler, opening of windows/doors, removal of roof), (vi) changing an appearance of the vehicle's interior (e.g., change of seat position, change display of products, change configuration of seats or other objects in the vehicle, (vii) audio actions (e.g., playing sounds, music, speech or etc.); (ix) moving to increase exposure to and/or attract attention of potential customer within range (e.g., within a line-of sight or within a reference radius from the location of the mobile service) of the brand promotion (e.g., change of speed, changing of lane, or etc.), and (x) re-routing the vehicle to a different location (e.g., different street) to change which potential customers are within range (e.g., within line-of sight). Further, the promotion performance may be conducted while the promotion vehicle is moving, or during various stops along a calculated route. In addition, the promotion request may specify the promotion vehicle to travel below or above a predetermined speed limit during the promotion performance.

In operation S411, the promotion vehicle or the central server determines whether one or more of the environment attributes changed during the performance of the promotion. If one or more of the environment attributes does change (e.g., density of population at various locations within a reference range of the service offering vehicle, change in weather, completion of an event, and etc.), the method proceeds to operation S412. In operation S412, a promotion route of the promotion vehicle is modified in view of the modified environment attributes. If the environment attributes does not change in operation S411, the method proceeds to operation S413.

In operation S413, a determination of whether or not the promotion performance has been completed or not is made. If the promotion performance is determined not to have been completed, the method proceeds back to operation S410. On the other hand, if the promotion performance is determined to have been completed in operation S413, then the method proceeds to operation S414.

In operation S414, the promotion vehicle transmits a notification of completion to the service offering vehicle or the centralized server. Upon transmitting of the notification of completion, proof dataset is collected in S415. In an example, the proof dataset may be collected by the promotion vehicle that performed the promotion, another vehicle, an unmanned aerial device (e.g., drone) or the like. More specifically, upon receiving of the notification of completion, a determination may be made as to which vehicle/device would be assigned to collect the proof dataset. In an example, the proof dataset may include a dataset which shows that the brand promotion has taken place as specified in the promotion request. The proof dataset may include, without limitation, a promotion vehicle ID, proof of brand promotion execution, environment attributes, and user assessment data.

In operation S416, a determination as to whether the proof dataset meets the condition set in the promotion request is made. In an example, such determination may be made by a proof dataset assessment algorithm stored in a memory of the centralized server. If the proof dataset is determined to be unsatisfactory, the method will proceed back to operation S415. In such a scenario, collection of proof dataset may be performed by another vehicle or device. For example, if the first attempt at collection of proof dataset was initially made by the promotion vehicle that performed the promotion, a second attempt may be performed by another vehicle, an unmanned aerial device (e.g., drone), a system of cameras mounted on various fixed structures, or the like.

If the proof dataset is determined to be satisfactory, the method will proceed to operation S417, in which the centralized server or the service offering vehicle will determine and provide reward to the promotion vehicle. In an example, the reward may be determined by a proof of customer interaction assessment algorithm stored in a memory of the centralized server. According to aspects of the present disclosure, conditions for the reward and the reward amount may be specified in the promotion request.

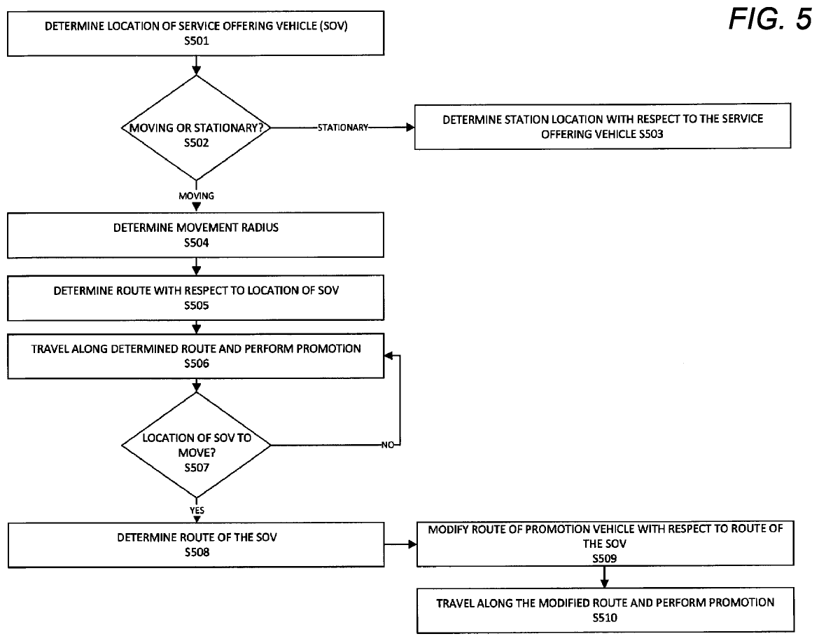

FIG. 5 illustrates a method for determining a promotion route with respect to a positioning of a service offering vehicle, according to aspects of the present disclosure.

In operation S501, a location of service offering vehicle may be determined. In an example, the location of the service offering vehicle may be determined by a central server based on a location signal transmitted by the service offering vehicle to the central server. Alternatively, the location of the service offering vehicle may be determined based on a promotion request.

In operation S502, a determination as to whether the promotion vehicle is expected to move or be stationary during the promotion performance is made. In an example, the promotion request may specify whether the promotion performance is to be stationary or moving.

If the promotion performance is determined to be stationary in operation S502, the method proceeds to method S503. In operation S503, the promotion vehicle determines a location to be stationed at with respect to the location of the service offering vehicle. In an example, the location to be stationed may be adjacent to the location of the service offering vehicle, or it may be a designated location at a venue (e.g., designated parking spot). Further, if multiple promotion vehicles are assigned to the promotion performance, the location to be stationed may be determined with respect to both the service offering vehicle and other promotion vehicles present. In an example, each of the multiple promotion vehicles may be designated a location, or each of the promotion vehicles will be located to an available location among multiple designated locations (e.g., designated parking spots, a certain distance away from the service offering vehicle, or etc.). More specifically, if a location behind the service offering vehicle is occupied by another promotion vehicle at the time of arrival by the promotion vehicle, the late arriving promotion vehicle will take a location in front of the service offering vehicle.

If the promotion performance is determined to be moving, either constantly or with one or more stops along a route, in operation S502, the method proceeds to operation S504. In operation S504, a movement radius for the promotion performance is determined. In an example, the movement radius may be determined with respect to the service offering vehicle. Further, the movement radius may be specified by the promotion request, and/or determined in view of one or more environment attributes. More specifically, the promotion request may specify a value for the movement radius or a range of values. In an example, the range of values may specify a minimum value and a maximum value, which may be adjusted based on one or more environment attributes. If the maximum value specifies 0.2 mile from the service offering vehicle, but determines that majority of people (e.g., >80%) that may be exposed to the performance promotion within the 0.2 mile radius are located within the 0.1 mile radius from the service offering vehicle, the movement radius may be adjusted to the 0.1 mile radius value. According to aspects of the present disclosure, the movement radius value may be subject to change if the one or more environment attributes change.

In operation S505, the promotion vehicle or the centralized server determines a promotion route within the movement radius with respect to the location of the service offering vehicle. In an example, the promotion route may be determined based on amount of exposure of the promotion performance. More specifically, if the one or more environmental attributes indicates large congregation of people at select locations within the movement radius, the promotion route may be specified or set to pass by such locations. Large congregation of people may be determined by the central server based on sensor data obtained via various vehicles, and or sensor data collected by the promotion vehicle as it drives towards the service offering vehicle.

Further, the promotion route may specify to temporarily stop at locations where a number of people detected by its sensors are greater than a predetermined number, or at locations indicated as having large congregation of people. In an example, the length of the stop may be predetermined or based on amount of interest detected by the promotion vehicle. More specifically, the length of stop may specify a minimum duration, but allows for a longer duration if amount of interest detected is greater than a predetermined value. Amount of interest detected may be determined by gaze directions of people at the stopped location. More specifically, if the gaze direction of a predetermined number of people, as detected by the sensors of the promotion vehicle, are directed towards the promotion vehicle, the promotion vehicle may determine to stay longer than the minimum duration. If the amount of interest detected by the promotion vehicle is less than the predetermined value, the promotion vehicle may proceed to along the promotion route after the minimum duration has passed.

Further, the promotion route may also specify traveling speed, or range of traveling speeds, of the promotion vehicle. For example, the traveling speed may be variably adjusted in accordance with a number of people detected by the sensors of the promotion vehicle. More specifically, the traveling speed may be inversely related with the number of people that are detected. As more people are detected, the promotion vehicle may travel slower.

In addition, audio output level may be variably adjusted in accordance with amount of people detected by its sensors and/or based on a sound level detected by a microphone of the promotion vehicle. For example, the audio output level may be increased as larger number of people are detected and/or the detected sound level increases.

In operation S506, the promotion vehicle travels along the determined promotion route and performs the promotion. In an example, the promotion may include displaying, on external displays of the promotion vehicle, advertisement images, logos videos and/or animations. Further directions to or location of the service offering vehicle may also be displayed. In addition, the promotion vehicle may operate its lights and actuators to bring attention to the promotion vehicle. For example, the promotion vehicle may utilize its light projectors to project images onto a road or to a building. Further still, the promotion vehicle may provide audio advertisements or information.

In addition, if certain number of people is detected as being attracted to the promotion, the promotion vehicle may make a temporary stop and provide promotional coupons (e.g., physical or electronic) via using its actuators. For example, a window or trunk may be opened to dispense or make accessible a physical coupon. Alternatively, the promotion vehicle may provide information for obtaining electronic coupons, such as dialing of a certain number or vising a certain website. Further, the promotion vehicle may also facilitate scheduling of an appointment at the service offering vehicle.

In operation S507, a determination of whether the service offering vehicle is moving or stationary is made. The determination of whether the service offering vehicle is moving or stationary may be made while the promotion vehicle is traveling along the determined promotion route. In an example, the service offering vehicle may determine to move to another location after a certain duration if the level of visits is below a predetermined threshold or after a particular event has ended (e.g., a sporting event). According to aspects of the present disclosure, the determination of movement of the service offering vehicle may be determined based on a communication established between the central server and the service offering vehicle. In another example, the service offering vehicle may transmit another promotion request or a modified promotion request indicating that the service offering vehicle is intending to move to another location. Further, the service offering vehicle may additionally provide a travel route the service offering vehicle is intending to take.

If the location of the service offering vehicle is determined not to move in operation S507, the promotion vehicle continues to travel along the determined promotion route in operation S506.

If the location of the service offering vehicle is determined to move in operation S507, a travel route of the service offering vehicle is determined in operation S508. In an example, a new service offering location and corresponding travel route to the new service offering location may be determined by the service offering vehicle, and transmitted to the centralized server and/or the promotion vehicle.

In operation S509, the promotion vehicle, in receipt of the new service offering location and the corresponding travel route to the new service offering location, modifies its promotion route. In an example, the modified promotion route may specify to follow the service offering vehicle to the new service offering location while performing the promotion. Alternatively, the modified promotion route may specify to travel ahead of the service offering vehicle and perform the promotion prior to the arrival of the new service offering location. In an example, the modified promotion route may be same as the travel route to the new service offering location by the service offering vehicle or may be different therefrom as their objectives may be different. More specifically, the service offering vehicle may be more interested in moving to the new service location as fastest it can to prepare for offering of service at the new service location, whereas the promotion vehicle may travel along a route which may garner most amount of attention.

In operation S510, the promotion vehicle travels along the modified promotion route while performing the promotion.

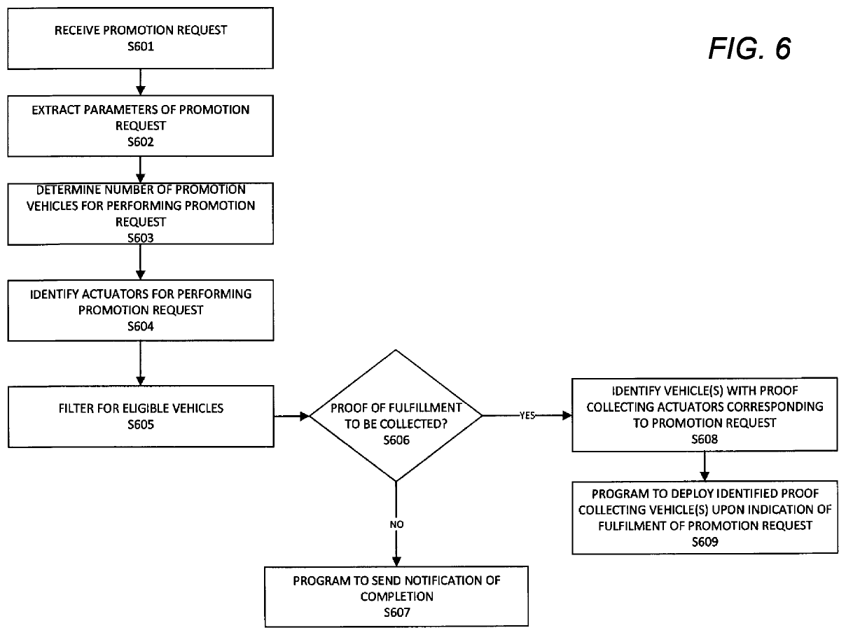

FIG. 6 shows a method for matching a promotion request to a promotion vehicle, according to aspects of the present disclosure.

In operation S601, a centralized server receives a promotion request, which may be generated by a service offering vehicle. However, aspects of the present disclosure are not limited thereto, such that the promotion request may be generated by a computing device, such as a mobile device, a smart phone, a smart watch, a stationary computer, a kiosk or the like.

In operation S602, the centralized server extracts the specified parameters or attributes of the promotion request. For example, the promotion request may have several parameters, which may be unpackaged and extracted for identifying qualified vehicles for performing of the promotion request. The parameters may include, without limitation, number of vehicles for performing the promotion request, required actuator(s) for performing the promotion request, timeframe of promotion performance, location of promotion performance, cost range, vehicle type, and the like.

In operation S603, a number of vehicles for performing the promotion request is identified by the centralized server. In an example, if the number of vehicles necessary for performing the promotion request is greater than 1, then the centralized server may automatically divide up the promotion request to multiple tasks to be performed by the participating or accepting promotion vehicles. The multiple tasks may be specified in relation to one another, which may specify a sub-promotion performance and/or a location of performance.

In operation S604, actuators for performing the promotion request are identified by the centralized server. For example, the promotion request may specify that the promotion vehicle be equipped with external displays for display of images or videos.

In operation S605, filtering of eligible promotion vehicles is performed. In an example, if filtering is performed at the centralized server, the centralized server may remove unqualified promotion vehicles from consideration for the promotion request. If filtering is performed at the promotion vehicle, each promotion vehicle may determine whether it would qualify to perform the promotion request.

In operation S606, a determination of whether proof of fulfillment is to be obtained is made. If no such proof is to be obtained, the accepting promotion vehicle is programmed to transmit indication of completion of promotion request upon completion of the promotion request in operation S607.

If proof of fulfillment is to be obtained, an identification of proof collecting vehicles or devices with qualifying proof collecting actuators (e.g., camera, microphone, light measurer, biological sensor, and the like) may be made in operation S608. In an example, the proof collecting vehicles or devices may include the promotion vehicle performing the promotion request, another vehicle that may be located within a reference range of the promotion request, an unmanned aerial device (e.g., drone), or the like.

Once the qualifying proof collecting vehicles or devices are identified, the proof collecting vehicles or devices may be programmed to deploy upon receiving an indication of completion or fulfilment of the promotion request in operation S609.

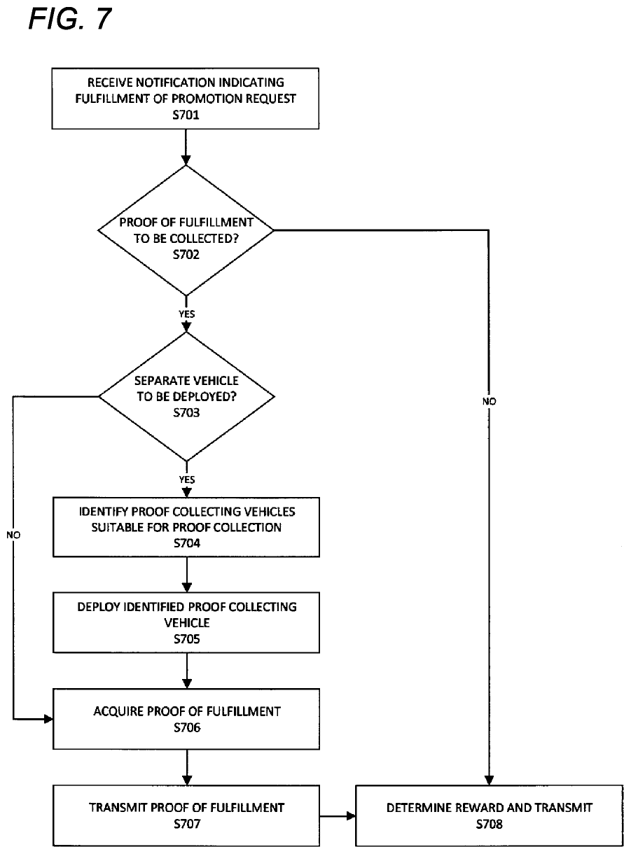

FIG. 7 shows a method for identifying a proof collection device for deployment, according to an aspect of the present disclosure.

In operation S701, a notification indicating fulfillment or completion of a promotion request may be received from a respective promotion vehicle. The notification may be received at a centralized server or at a service offering vehicle that issued the promotion request.

In operation S702, a determination of whether proof of fulfillment is to be collected or acquired is made. In an example, the determination may be made manually by a user of the service offering vehicle. Alternatively, the determination may be automatically made by the centralized server or the service offering vehicle based on one or more attributes of the promotion request.

If it is determined that the proof of fulfillment is not to be collected, a reward is determined and transmitted to the promotion vehicle in operation S708. In an example, the reward may be flat amount or a variable amount based on amount of business or interest generated by the promotion performance.

If it is determined that the proof of fulfillment is to be collected, a determination of whether a separate vehicle is to be deployed is made in operation S703. If it is determined that a separate vehicle is not to be deployed in operation S703, the promotion vehicle collects proof of fulfillment in operation S706, and transmits the proof of fulfillment to either the service offering vehicle or the centralized server in operation S707. Further, upon transmission of the proof of fulfillment, a reward is determined and transmitted to the promotion vehicle in operation S708.

If it is determined that a separate vehicle is to be deployed in operation S703, proof collecting vehicles suitable for proof of fulfillment are identified in operation S704. In an example, the proof collecting vehicles may be identified based on their equipped actuators, distance from the location of performance of the promotion request, travel route/time, type of vehicle and mode of travel. The proof collecting vehicles may include, without limitation, another promotion vehicle, an unmanned aerial device (e.g., drone) or the like. However, aspects of the present disclosure are not limited thereto, such that a stationary proof collecting system, such as a system of safety cameras installed or mounted to various structures, may be utilized.

Upon identification of suitable proof collecting vehicles in operation S704, one or more of the identified proof collecting vehicles are deployed in operation S705. A deployed prof collecting vehicle collects proof of fulfillment in operation S706, and transmits the proof of fulfillment to either the service offering vehicle or the centralized server in operation S707. Further, upon transmission of the proof of fulfillment, a reward is determined and transmitted to the promotion vehicle in operation S708.

Aspects of the present disclosure allow businesses providing a mobile service are enabled to dynamically promote their business offering (service, products) in locations within travel distance of the vehicle, but outside the range of its own promotion capabilities, such as nearby streets. Further, businesses providing a mobile service may tailor in real-time the promotion of their service or product to the status of the service offering vehicle (e.g. occupied, products in stock), the capabilities of the promotion vehicle (e.g. availability of outside screen, freedom to move to a desired location) and the status of the location (e.g. crowded street, good weather, traffic and etc.).

Further, according to other aspects of the present disclosure, users may be able to receive real-time information about nearby mobile services and may be provided with the ability to order such a service via a promotion vehicle. In addition, vehicles with advertising capabilities may earn extra revenue by promoting services/products of service offering vehicles at times when the vehicle is not using the advertising capabilities for its own objectives; and letting other vehicles collect useful data, e.g. reaction to promotions. Such vehicles may additionally earn extra revenue by collecting data about user reactions to certain brand promotions, which may be valuable for the service offering vehicle. Also, the vehicles may earn extra revenue by receiving a share of the resulted extra revenue for the service offering vehicle through click-through-fees, which may be money earned for a brand promotion, followed by a user purchase.

In addition to the above, according to aspects of the present disclosure, a brand promotion could be designed by the service offering vehicle to create a multi-vehicle effect, such as small number of promotion vehicles promoting the mobile service or brand to a specific location in a desired sequence.

In an alternative embodiment, the information related to the service may be shared among a plurality of the service offering vehicles. In one example, the service offering vehicles include taxies, and the information related to the service includes information on existence of a person on the street who wishes a taxi ride. Each taxi includes a communication circuit for a mobile network, a wireless local area network, etc.; a location information obtaining device; and a passenger find button. When the taxi driver recognizes a person on the street who wishes a taxi ride, e.g., a person raising his hand, and the taxi can not take on the person, the taxi driver presses the passenger find button. If the passenger find button is pressed, the taxi transmits the location information obtained by the location information obtaining device and the information indicating that a passenger is found to another taxi via the communication circuit. The information may be transmitted using direct communication between taxies, via a mobile network or the Internet, or via a relay device mounted on a roadside fixture such as a vending machine.

According to various aspects of the present disclosure, various benefits and/or resolutions to problems may be addressed. For example, a real-world mobile equivalent of an advert hyperlink, including click through fees may be created. Further, communication to users regarding the availability of nearby mobile services, such as shops that come to you, autonomous taxi services may be provided. Further, an ability of mobile businesses to extend their business to nearby streets/locations via promotion vehicles may be provided. Also, dynamic use and monetization of third-party vehicle capabilities as a platform to help mobile businesses promote a product or service may be provided. In addition, actions of a third-party vehicle leading to a purchase by a user from a mobile business, or leading to other commercially relevant user data (e.g. a user reaction to a promotion) may be tracked.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a system to execute a coordinated promotion of a product or service between at least two vehicles and then collect proof of user actions of interest in response to the promotion (gauging the pedestrian's attention, detecting gesture signals) is provided.

According to another aspect of the present disclosure, a method to execute a coordinated promotion of a product or service between at least two vehicles and then collect proof of user actions of interest in response to the promotion (gauging the pedestrian's attention, detecting gesture signals) is provided.

According to an aspect of the present disclosure, a method is provided for supporting a nomadic mobile servicing vehicle. The method includes transmitting, by a first vehicle and to a server, a promotion request, the promotion request specifying a location of the first vehicle; acquiring and transmitting, by one or more second vehicles to the server, environment attributes of an environment within a reference distance of the location of the first vehicle; extracting, by the server, conditions specified in the promotion request; transmitting, by the server to a third vehicle, the promotion request for fulfillment; determining, by the server, a distance range of the promotion request based on the conditions specified in the promotion request; determining, by the third vehicle, a promotion route within the distance range; and executing, by the third vehicle, a promotion operation while traveling along the promotion route.

According to another aspect of the present disclosure, the method further includes matching, by the server, the promotion request with a plurality of third vehicles registered at the server based on the conditions specified in the promotion request and one or more attributes of the third vehicles; transmitting, by the server and to the matched third vehicles, the promotion request for acceptance; receiving, from at least one of the third vehicles receiving the promotion request, an acceptance to fulfill the promotion request; and selecting, by the server, the third vehicle among the accepting third vehicles for executing the promotion operation.

According to another aspect of the present disclosure, the promotion operation is executed using one or more actuators provided on the third vehicle.

According to yet another aspect of the present disclosure, the one or more actuators include at least one of an external display, a head light, a door, a window, a spoiler, and an audio system.

According to still another aspect of the present disclosure, the conditions specify at least a traveling speed of the third vehicle when executing the promotion operation.

According to another aspect of the present disclosure, the promotion route is determined based on the one or more environment attributes.

According to another aspect of the present disclosure, the promotion route includes a temporary stop along the promotion route.

According to yet another aspect of the present disclosure, the temporary stop corresponds to a location along the promotion route detected as having a number of people above a reference value.

According to still another aspect of the present disclosure, a duration of the temporary stop is based on a response by the people, the response including a gaze direction towards the third vehicle.

According to a further aspect of the present disclosure, the one or more environment attributes include a number/density of people, a traffic level or level of congestion, a number of other mobile services, presence of an event, or a number of other vehicles.

According to another aspect of the present disclosure, the method further includes determining a movement of the first vehicle while the third vehicle travels along the promotion route; determining a new intended location of the first vehicle; determining a travel route of the first vehicle to the new intended location; modify, by the third vehicle, the promotion route with respect to the travel route of the first vehicle; and traveling, by the third vehicle, along the modified promotion route while executing the promotion operation.

According to another aspect of the present disclosure, the modified promotion route of the third vehicle and the travel route of the first vehicle are the same.

According to yet another aspect of the present disclosure, the modified promotion route of the third vehicle is different from the travel route of the first vehicle.

According to still another aspect of the present disclosure, the promotion operation indicates the location of the first vehicle.

According to another aspect of the present disclosure, the method further includes receiving, from the third vehicle, a notification of completion of the promotion operation; determining, by the server, whether proof of fulfillment is to be collected; when the proof of fulfillment is determined to be collected, identifying, by the server, a proof collecting vehicle equipped with an actuator configured to collect the proof of fulfillment; and deploying, by the server, the proof collecting vehicle for collection of the proof of fulfillment.

According to another aspect of the present disclosure, the proof collecting vehicle is the third vehicle.

According to yet another aspect of the present disclosure, the proof collecting vehicle is an unmanned aerial device.

According to still another aspect of the present disclosure, the method further includes determining, by the server, whether or not the proof of fulfillment is acceptable; when the proof of fulfilment is determined to be acceptable, determining, by the server, a reward for the third vehicle; and transmitting, to the third vehicle, the determined reward.

According to another aspect of the present disclosure, a non-transitory computer readable storage medium that stores a computer program, the computer program, when executed by a processor, causing a computer apparatus to perform a process for supporting a nomadic mobile servicing vehicle. The process includes transmitting, by a first vehicle and to a server, a promotion request, the promotion request specifying a location of the first vehicle; acquiring and transmitting, by one or more second vehicles to the server, environment attributes of an environment within a reference distance of the location of the first vehicle; extracting, by the server, conditions specified in the promotion request; transmitting, by the server to a third vehicle, the promotion request for fulfillment; determining, by the server, a distance range of the promotion request based on the conditions specified in the promotion request; determining, by the third vehicle, a promotion route within the distance range; and executing, by the third vehicle, a promotion operation while traveling along the promotion route.

According to yet another aspect of the present disclosure, a computer apparatus for supporting a nomadic mobile servicing vehicle is provided. The computer apparatus includes a memory that stores instructions, and a processor that executes the instructions, in which, when executed by the processor, the instructions cause the processor to perform a set of operations. The set of operations includes transmitting, by a first vehicle and to a server, a promotion request, the promotion request specifying a location of the first vehicle; acquiring and transmitting, by one or more second vehicles to the server, environment attributes of an environment within a reference distance of the location of the first vehicle; extracting, by the server, conditions specified in the promotion request; transmitting, by the server to a third vehicle, the promotion request for fulfillment; determining, by the server, a distance range of the promotion request based on the conditions specified in the promotion request; determining, by the third vehicle, a promotion route within the distance range; and executing, by the third vehicle, a promotion operation while traveling along the promotion route.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The present application claims the benefit of U.S. Provisional Patent Application No. 62/735,272 filed on Sep. 24, 2018. The entire disclosure of the above-identified application, including the specifications, drawings and/or claims, is incorporated herein by reference in its entirety.

1. A method for supporting a nomadic mobile servicing vehicle, using a plurality of vehicles, the method comprising:
transmitting, by a first vehicle and to a server, a promotion request, the promotion request specifying a location of the first vehicle;
acquiring and transmitting, by one or more second vehicles to the server, environment attributes of an environment within a reference distance of the location of the first vehicle;
extracting, by the server, conditions specified in the promotion request;
transmitting, by the server to a third vehicle, the promotion request for fulfillment;
determining, by the server, a distance range of the promotion request based on the conditions specified in the promotion request;
determining, by the third vehicle, a promotion route within the distance range; and
executing, by the third vehicle, a promotion operation while traveling along the promotion route.

2. The method of claim 1, further comprising:
matching, by the server, the promotion request with a plurality of third vehicles registered at the server based on the conditions specified in the promotion request and one or more attributes of the third vehicles;
transmitting, by the server and to the matched third vehicles, the promotion request for acceptance;
receiving, from at least one of the third vehicles receiving the promotion request, an acceptance to fulfill the promotion request; and
selecting, by the server, the third vehicle among the accepting third vehicles for executing the promotion operation.

3. The method of claim 1, wherein the promotion operation is executed using one or more actuators provided on the third vehicle.

4. The method of claim 3, wherein the one or more actuators include at least one of an external display, a head light, a door, a window, a spoiler, and an audio system.

5. The method of claim 1, wherein the conditions specify at least a traveling speed of the third vehicle when executing the promotion operation.

6. The method of claim 1, wherein the promotion route is determined based on the one or more environment attributes.

7. The method of claim 1, wherein the promotion route includes a temporary stop along the promotion route.

8. The method of claim 1, wherein the temporary stop corresponds to a location along the promotion route detected as having a number of people above a reference value.

9. The method of claim 1, wherein a duration of the temporary stop is based on a response by the people, the response including a gaze direction towards the third vehicle.

10. The method of claim 1, wherein the one or more environment attributes include a number/density of people, a traffic level or level of congestion, a number of other mobile services, presence of an event, or a number of other vehicles.

11. The method of claim 1, further comprising:
determining a movement of the first vehicle while the third vehicle travels along the promotion route;
determining a new intended location of the first vehicle;
determining a travel route of the first vehicle to the new intended location;
modify, by the third vehicle, the promotion route with respect to the travel route of the first vehicle; and
traveling, by the third vehicle, along the modified promotion route while executing the promotion operation.

12. The method of claim 11, wherein the modified promotion route of the third vehicle and the travel route of the first vehicle are the same.

13. The method of claim 11, wherein the modified promotion route of the third vehicle is different from the travel route of the first vehicle.

14. The method of claim 1, wherein the promotion operation indicates the location of the first vehicle.

15. The method of claim 1, further comprising:
receiving, from the third vehicle, a notification of completion of the promotion operation;
determining, by the server, whether proof of fulfillment is to be collected;
when the proof of fulfillment is determined to be collected, identifying, by the server, a proof collecting vehicle equipped with an actuator configured to collect the proof of fulfillment; and
deploying, by the server, the proof collecting vehicle for collection of the proof of fulfillment.

16. The method of claim 15, wherein the proof collecting vehicle is the third vehicle.

17. The method of claim 15, wherein the proof collecting vehicle is an unmanned aerial device.

18. The method of claim 15, further comprising:
determining, by the server, whether or not the proof of fulfillment is acceptable;
when the proof of fulfilment is determined to be acceptable, determining, by the server, a reward for the third vehicle; and
transmitting, to the third vehicle, the determined reward.

19. A non-transitory computer readable storage medium that stores a computer program, the computer program, when executed by a processor, causing a computer apparatus to perform a process for supporting a nomadic mobile servicing vehicle, the process comprising:
transmitting, by a first vehicle and to a server, a promotion request, the promotion request specifying a location of the first vehicle;
acquiring and transmitting, by one or more second vehicles to the server, environment attributes of an environment within a reference distance of the location of the first vehicle;
extracting, by the server, conditions specified in the promotion request;
transmitting, by the server to a third vehicle, the promotion request for fulfillment;
determining, by the server, a distance range of the promotion request based on the conditions specified in the promotion request;
determining, by the third vehicle, a promotion route within the distance range; and
executing, by the third vehicle, a promotion operation while traveling along the promotion route.

20. A computer apparatus for supporting a nomadic mobile servicing vehicle, the computer apparatus comprising:
a memory that stores instructions, and
a processor that executes the instructions,
wherein, when executed by the processor, the instructions cause the processor to perform operations comprising:
transmitting, by a first vehicle and to a server, a promotion request, the promotion request specifying a location of the first vehicle;
acquiring and transmitting, by one or more second vehicles to the server, environment attributes of an environment within a reference distance of the location of the first vehicle;
extracting, by the server, conditions specified in the promotion request;
transmitting, by the server to a third vehicle, the promotion request for fulfillment;
determining, by the server, a distance range of the promotion request based on the conditions specified in the promotion request;
determining, by the third vehicle, a promotion route within the distance range; and
executing, by the third vehicle, a promotion operation while traveling along the promotion route.
